(19) United States
(12) Patent Application Publication
(10) Pub. No.: US 2026/0113466 A1
(43) Pub. Date: Apr. 23, 2026

(54) CHANNEL DYNAMIC RANGE ADJUSTMENT METHOD VIA NON-LINEAR FUNCTION FOR FEATURE TENSOR COMPRESSION IN SPLIT INFERENCE

(71) Applicant: InterDigital VC Holdings, Inc., Wilmington, DE (US)

(72) Inventors: Hyomin Choi, Sunnyvale, CA (US); Fabien Racape, San Francisco, CA (US); Syed Mateen Ul haq, Mountain View, CA (US)

(73) Assignee: InterDigital VC Holdings, Inc., Wilmington, DE (US)

(21) Appl. No.: 18/918,917

(22) Filed: Oct. 17, 2024

(51) Int. Cl. H04N 19/196; H04N 19/167; H04N 19/172

(52) U.S. Cl. CPC H04N 19/196; H04N 19/167; H04N 19/172

(57) ABSTRACT

Systems, methods, and instrumentalities are disclosed for a channel dynamic range adjustment process, e.g., via a non-linear function for feature tensor compression in split inference. In examples, a device for video decoding (e.g., a video decoding device) may obtain a feature tensor associated with a video. The feature tensor may be associated with multiple channels. The device may perform dynamic range adjustment on a channel level and use non-linear models. For example, the device may adjust a channel dynamic range of a first channel that is associated with the feature tensor using a first non-linear model and adjust a channel dynamic range on a second channel that is associated with the feature tensor using a second non-linear model. The device may determine reconstructed features based on the adjusted first channel and the adjusted second channel. The device may decode the video based on the determined reconstructed features.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and instrumentalities are disclosed for a channel dynamic range adjustment process, e.g., via a non-linear function for feature tensor compression in split inference.

In examples, a device for video decoding (e.g., a video decoding device) may include a processor. The processor may be configured to perform one or more of the following.

In examples, the device may obtain a feature tensor associated with a video. The feature tensor may be associated with multiple channels. The device may perform dynamic range adjustment on a channel level and use non-linear models. For example, the device may adjust a channel dynamic range of a first channel that is associated with the feature tensor using a first non-linear model and adjust a channel dynamic range on a second channel that is associated with the feature tensor using a second non-linear model. The device may determine reconstructed features based on the adjusted first channel and the adjusted second channel. The device may decode the video based on the determined reconstructed features.

In examples, the device may determine the first non-linear model for adjusting the channel dynamic range of the first channel based on a first adjustment parameter. The device may determine the second non-linear model for adjusting the channel dynamic range of the second channel based on a second adjustment parameter. The first and/or second adjustment parameter may be (e.g., may include and/or may be associated with) a slope adjustment parameter, a slope adjustment coefficient, a scale parameter, a scale value, and/or the like.

In examples, the device may decode a first adjustment parameter for the first channel from video data (e.g., parse the slope adjustment values from the bitstream). The device may determine the first non-linear model for adjusting the channel dynamic range of the first channel based on the first adjustment parameter. The device may decode a second adjustment parameter for the second channel from the video data (e.g., parse the slope adjustment values from the bitstream). The device may determine the second non-linear model for adjusting the channel dynamic range of the second channel based on the second adjustment parameter.

In examples, the device may obtain a channel dynamic range adjustment refresh period indication. Based on the channel dynamic range adjustment refresh period indication, the device may determine to decode adjustment parameters for channel dynamic range adjustment. The device may decode a first adjustment parameter for the first channel from the video data. The device may determine the first non-linear model for adjusting the channel dynamic range of the first channel based on the first adjustment parameter. The device may decode a second adjustment parameter for the second channel from the video data. The device may determine the second non-linear model for adjusting the channel dynamic range of the second channel based on the second adjustment parameter.

In examples, the device may obtain a channel dynamic range adjustment refresh period indication. Based on the channel dynamic range adjustment refresh period indication, the device may determine to use adjustment parameters associated with a previous picture. For example, the device may determine not to refresh the adjustment parameters (e.g., yet) and use the same adjustment parameters as before (e.g., from the previous picture). The device may determine the first non-linear model for adjusting the channel dynamic range of the first channel based on a first adjustment parameter associated with the previous picture. The device may determine the second non-linear model for adjusting the channel dynamic range of the second channel based on a second adjustment parameter with the previous picture.

In examples, the device may obtain a probable channel dynamic range adjustment indication. The probable channel dynamic range adjustment indication may be configured to indicate a default channel dynamic range adjustment parameter value. For the first channel associated with the feature tensor, the device may obtain a probable channel dynamic range adjustment usage indication. Based on the probable channel dynamic range adjustment usage indication associated with the first channel, the device may determine to use the default channel dynamic range adjustment parameter value for the first channel. The device may determine the first non-linear model for adjusting the channel dynamic range of the first channel based on the default channel dynamic range adjustment parameter value.

In examples, the device may obtain a probable channel dynamic range adjustment indication. The probable channel dynamic range adjustment indication may be configured to indicate a default channel dynamic range adjustment parameter value. For the first channel associated with the feature tensor, the device may obtain a probable channel dynamic range adjustment usage indication. Based on the probable channel dynamic range adjustment usage indication associated with the first channel, the device may determine not to use the default channel dynamic range adjustment parameter value for the first channel. The device may decode an adjustment parameter for the first channel from video data. The device may determine the first non-linear model for adjusting the channel dynamic range of the first channel based on the adjustment parameter for the first channel.

In examples, the device may obtain a common channel dynamic range adjustment indication. The common channel dynamic range adjustment indication may be configured to indicate whether to use a common channel dynamic range adjustment parameter value for channels associated with the feature tensor. Based on the common channel dynamic range adjustment indication, the device may determine to use the common channel dynamic range adjustment parameter value for channels associated with the feature tensor. The device may determine the first non-linear model for adjusting the channel dynamic range of the first channel based on the common channel dynamic range adjustment parameter value. The device may determine the second non-linear model for adjusting the channel dynamic range of the second channel based on the common channel dynamic range adjustment parameter.

In examples, the device may obtain, based on video data, a common channel dynamic range adjustment indication. The common channel dynamic range adjustment indication may be configured to indicate whether to use a common channel dynamic range adjustment parameter value for channels associated with the feature tensor. Based on the common channel dynamic range adjustment indication, the device may determine not to use the common channel dynamic range adjustment parameter value for channels associated with the feature tensor. The device may determine a first adjustment parameter for the first channel based on the video data. The device may determine a second adjustment parameter for the second channel based on the video data. The device may determine the first non-linear model for adjusting the channel dynamic range of the first channel based on the first adjustment parameter. The device may determine the second non-linear model for adjusting the channel dynamic range of the second channel based on the second adjustment parameter.

In examples, a device for video encoding (e.g., a video encoding device) may include a processor. The processor may be configured to perform one or more of the following.

In examples, the device may obtain a feature tensor associated with a video. The device may adjust a channel dynamic range of a first channel associated with the feature tensor using a first non-linear model. In examples, the first non-linear model may be associated with a first adjustment parameter. In examples, the first non-linear model may be associated with a logit function. The device may adjust a channel dynamic range on a second channel associated with the feature tensor using a second non-linear model. In examples, the second non-linear model may be associated with a second adjustment parameter. In examples, the second non-linear model may be associated with a logit function. The device may encode the video based on the adjusted feature tensor having the first channel and the second channel.

In examples, the device may determine a first adjustment parameter associated with the first non-linear model for adjusting the channel dynamic range of the first channel. The device may determine a second adjustment parameter associated with the second non-linear model for adjusting the channel dynamic range of the second channel. The device may include, in video data, an indication of the first adjustment parameter and the second adjustment parameter.

In examples, the feature tensor may be associated with multiple channels. The device may determine a plurality of adjustment parameters associated with the plurality of channels. The device may determine a default channel dynamic range adjustment parameter value based on the plurality of adjustment parameters associated with the plurality of channels. The device may include, in the video data, a probable channel dynamic range adjustment indication. For example, the probable channel dynamic range adjustment indication may be configured to indicate the default channel dynamic range adjustment parameter value.

In examples, the feature tensor may be associated with multiple channels. The device may determine multiple parameters associated with the multiple channels. The device may determine a default channel dynamic range adjustment parameter value based on the multiple adjustment parameters associated with the multiple channels. For the first channel associated with the feature tensor, the device may determine a first probable channel dynamic range adjustment usage indication based on the default channel dynamic range adjustment parameter value and a first adjustment parameter associated with the first non-linear model for adjusting the channel dynamic range of the first channel. For the second channel associated with the feature tensor, the device may determine a second probable channel dynamic range adjustment usage indication based on the default channel dynamic range adjustment parameter value and a second adjustment parameter associated with the second non-linear model for adjusting the channel dynamic range of the second channel. The device may include, in the video data, a probable channel dynamic range adjustment indication. The probable channel dynamic range adjustment indication may be configured to indicate the default channel dynamic range adjustment parameter value, the first probable channel dynamic range adjustment usage indication for the first channel, and/or the second probable channel dynamic range adjustment usage indication for the second channel.

In examples, the device may determine whether to use a common channel dynamic range adjustment parameter value for channels associated with the feature tensor. Based on a determination to not use the common channel dynamic range adjustment parameter value for channels associated with the feature tensor, the device may determine a first adjustment parameter for the first channel and a second adjustment parameter for the second channel. The device may include, in video data, a common channel dynamic range adjustment indication. The common channel dynamic range adjustment indication may be configured to indicate not to use the common channel dynamic range adjustment parameter value for channels associated with the feature tensor. The device may include, in the video data, an indication of the first adjustment parameter and an indication of the second adjustment parameter.

In examples, the device may determine a channel dynamic range adjustment refresh period. The device may include, in the video data, a channel dynamic range adjustment refresh period indication. The channel dynamic range adjustment refresh period indication may be configured to indicate the determined channel dynamic range adjustment refresh period.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. shows an example video decoder according to one or more embodiments of the present disclosure.

FIG. 4 shows an example video coding for machines pipeline.

FIG. 5 shows an example of pipeline feature coding for machines (FCM).

FIG. 6 shows example regions with convolutional neural network (RCNN) architecture.

FIG. 7 shows example shapes tensors to transmit (e.g., considering the split point after the backbone network of a generalized R-CNN architecture).

FIG. 8 shows an example shallow network architecture for multi-scale feature fusion module taking the multiple feature tensors as input, e.g., P2, P3, P4, P5 from the Faster R-CNN at Feature Pyramid Network.

FIG. 9A shows an example feature conversion.

FIG. 9B shows an example inverse feature conversion in FCM.

FIG. 10 shows an example of tiled feature channels into a packed frame.

FIG. 11A shows an example of conversion with the channel dynamic range adjustment in an encoder.

FIG. 11B shows an example of conversion with the channel dynamic range restoration in a decoder.

FIG. 12 shows an example flowchart to parse s_{dec}.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

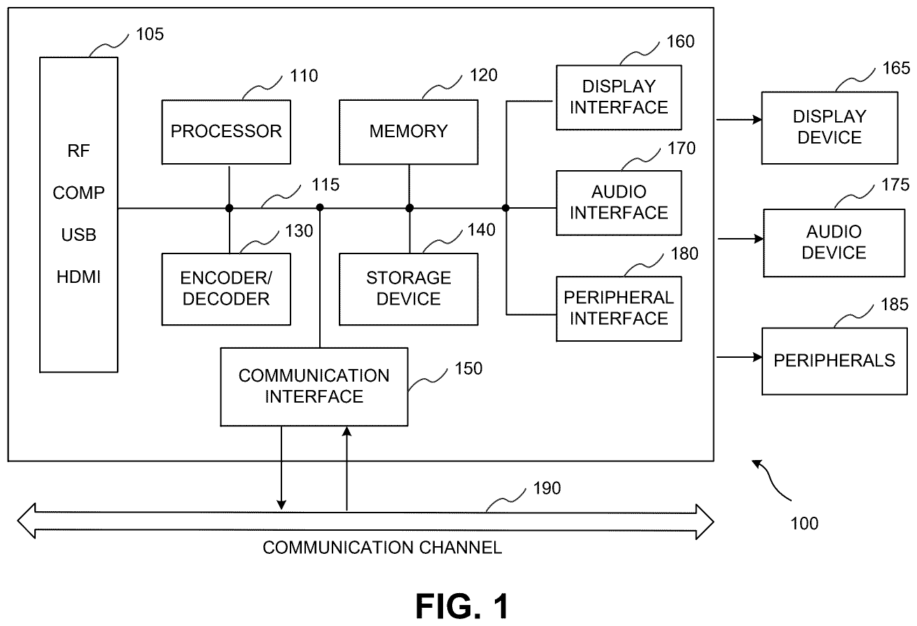

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., 12C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

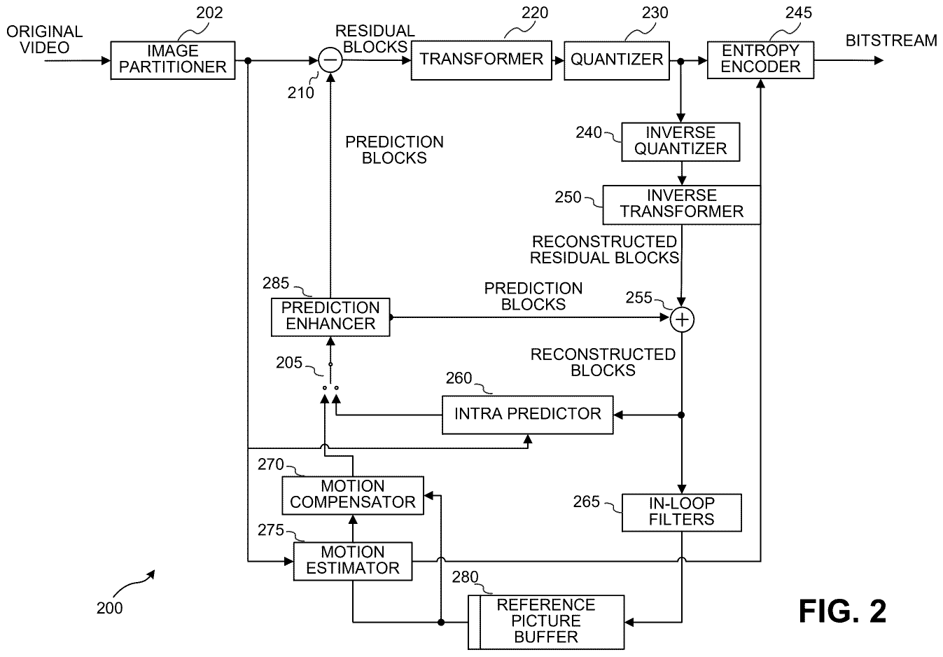

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Systems, methods, and instrumentalities are disclosed for a channel dynamic range adjustment process, e.g., via a non-linear function for feature tensor compression in split inference.

In examples, a device for video decoding (e.g., a video decoding device) may include a processor. The processor may be configured to perform one or more of the following.

In examples, the device may obtain a feature tensor associated with a video. The feature tensor may be associated with multiple channels. The device may perform dynamic range adjustment on a channel level and use non-linear models. For example, the device may adjust a channel dynamic range of a first channel that is associated with the feature tensor using a first non-linear model and adjust a channel dynamic range on a second channel that is associated with the feature tensor using a second non-linear model. The device may determine reconstructed features based on the adjusted first channel and the adjusted second channel. The device may decode the video based on the determined reconstructed features.

In examples, the device may determine the first non-linear model for adjusting the channel dynamic range of the first channel based on a first adjustment parameter. The device may determine the second non-linear model for adjusting the channel dynamic range of the second channel based on a second adjustment parameter. The first and/or second adjustment parameter may be (e.g., may include and/or may be associated with) a slope adjustment parameter, a slope adjustment coefficient, a scale parameter, a scale value, and/or the like.

In examples, the device may decode a first adjustment parameter for the first channel from video data (e.g., parse the slope adjustment values from the bitstream). The device may determine the first non-linear model for adjusting the channel dynamic range of the first channel based on the first adjustment parameter. The device may decode a second adjustment parameter for the second channel from the video data (e.g., parse the slope adjustment values from the bitstream). The device may determine the second non-linear model for adjusting the channel dynamic range of the second channel based on the second adjustment parameter.

In examples, the device may obtain a channel dynamic range adjustment refresh period indication. Based on the channel dynamic range adjustment refresh period indication, the device may determine to decode adjustment parameters for channel dynamic range adjustment. The device may decode a first adjustment parameter for the first channel from the video data. The device may determine the first non-linear model for adjusting the channel dynamic range of the first channel based on the first adjustment parameter. The device may decode a second adjustment parameter for the second channel from the video data. The device may determine the second non-linear model for adjusting the channel dynamic range of the second channel based on the second adjustment parameter.

In examples, the device may obtain a channel dynamic range adjustment refresh period indication. Based on the channel dynamic range adjustment refresh period indication, the device may determine to use adjustment parameters associated with a previous picture. For example, the device may determine not to refresh the adjustment parameters (e.g., yet) and use the same adjustment parameters as before (e.g., from the previous picture). The device may determine the first non-linear model for adjusting the channel dynamic range of the first channel based on a first adjustment parameter associated with the previous picture. The device may determine the second non-linear model for adjusting the channel dynamic range of the second channel based on a second adjustment parameter with the previous picture.

In examples, the device may obtain a probable channel dynamic range adjustment indication. The probable channel dynamic range adjustment indication may be configured to indicate a default channel dynamic range adjustment parameter value. For the first channel associated with the feature tensor, the device may obtain a probable channel dynamic range adjustment usage indication. Based on the probable channel dynamic range adjustment usage indication associated with the first channel, the device may determine to use the default channel dynamic range adjustment parameter value for the first channel. The device may determine the first non-linear model for adjusting the channel dynamic range of the first channel based on the default channel dynamic range adjustment parameter value.

In examples, the device may obtain a probable channel dynamic range adjustment indication. The probable channel dynamic range adjustment indication may be configured to indicate a default channel dynamic range adjustment parameter value. For the first channel associated with the feature tensor, the device may obtain a probable channel dynamic range adjustment usage indication. Based on the probable channel dynamic range adjustment usage indication associated with the first channel, the device may determine not to use the default channel dynamic range adjustment parameter value for the first channel. The device may decode an adjustment parameter for the first channel from video data. The device may determine the first non-linear model for adjusting the channel dynamic range of the first channel based on the adjustment parameter for the first channel.

In examples, the device may obtain a common channel dynamic range adjustment indication. The common channel dynamic range adjustment indication may be configured to indicate whether to use a common channel dynamic range adjustment parameter value for channels associated with the feature tensor. Based on the common channel dynamic range adjustment indication, the device may determine to use the common channel dynamic range adjustment parameter value for channels associated with the feature tensor. The device may determine the first non-linear model for adjusting the channel dynamic range of the first channel based on the common channel dynamic range adjustment parameter value. The device may determine the second non-linear model for adjusting the channel dynamic range of the second channel based on the common channel dynamic range adjustment parameter.

In examples, the device may obtain, based on video data, a common channel dynamic range adjustment indication. The common channel dynamic range adjustment indication may be configured to indicate whether to use a common channel dynamic range adjustment parameter value for channels associated with the feature tensor. Based on the common channel dynamic range adjustment indication, the device may determine not to use the common channel dynamic range adjustment parameter value for channels associated with the feature tensor. The device may determine a first adjustment parameter for the first channel based on the video data. The device may determine a second adjustment parameter for the second channel based on the video data. The device may determine the first non-linear model for adjusting the channel dynamic range of the first channel based on the first adjustment parameter. The device may determine the second non-linear model for adjusting the channel dynamic range of the second channel based on the second adjustment parameter.

In examples, a device for video encoding (e.g., a video encoding device) may include a processor. The processor may be configured to perform one or more of the following.

In examples, the device may obtain a feature tensor associated with a video. The device may adjust a channel dynamic range of a first channel associated with the feature tensor using a first non-linear model. In examples, the first non-linear model may be associated with a first adjustment parameter. In examples, the first non-linear model may be associated with a logit function. The device may adjust a channel dynamic range on a second channel associated with the feature tensor using a second non-linear model. In examples, the second non-linear model may be associated with a second adjustment parameter. In examples, the second non-linear model may be associated with a logit function. The device may encode the video based on the adjusted feature tensor having the first channel and the second channel.

In examples, the device may determine a first adjustment parameter associated with the first non-linear model for adjusting the channel dynamic range of the first channel. The device may determine a second adjustment parameter associated with the second non-linear model for adjusting the channel dynamic range of the second channel. The device may include, in video data, an indication of the first adjustment parameter and the second adjustment parameter.

In examples, the feature tensor may be associated with multiple channels. The device may determine a plurality of adjustment parameters associated with the plurality of channels. The device may determine a default channel dynamic range adjustment parameter value based on the plurality of adjustment parameters associated with the plurality of channels. The device may include, in the video data, a probable channel dynamic range adjustment indication. For example, the probable channel dynamic range adjustment indication may be configured to indicate the default channel dynamic range adjustment parameter value.

In examples, the feature tensor may be associated with multiple channels. The device may determine multiple parameters associated with the multiple channels. The device may determine a default channel dynamic range adjustment parameter value based on the multiple adjustment parameters associated with the multiple channels. For the first channel associated with the feature tensor, the device may determine a first probable channel dynamic range adjustment usage indication based on the default channel dynamic range adjustment parameter value and a first adjustment parameter associated with the first non-linear model for adjusting the channel dynamic range of the first channel. For the second channel associated with the feature tensor, the device may determine a second probable channel dynamic range adjustment usage indication based on the default channel dynamic range adjustment parameter value and a second adjustment parameter associated with the second non-linear model for adjusting the channel dynamic range of the second channel. The device may include, in the video data, a probable channel dynamic range adjustment indication. The probable channel dynamic range adjustment indication may be configured to indicate the default channel dynamic range adjustment parameter value, the first probable channel dynamic range adjustment usage indication for the first channel, and/or the second probable channel dynamic range adjustment usage indication for the second channel.

In examples, the device may determine whether to use a common channel dynamic range adjustment parameter value for channels associated with the feature tensor. Based on a determination to not use the common channel dynamic range adjustment parameter value for channels associated with the feature tensor, the device may determine a first adjustment parameter for the first channel and a second adjustment parameter for the second channel. The device may include, in video data, a common channel dynamic range adjustment indication. The common channel dynamic range adjustment indication may be configured to indicate not to use the common channel dynamic range adjustment parameter value for channels associated with the feature tensor. The device may include, in the video data, an indication of the first adjustment parameter and an indication of the second adjustment parameter.

In examples, the device may determine a channel dynamic range adjustment refresh period. The device may include, in the video data, a channel dynamic range adjustment refresh period indication. The channel dynamic range adjustment refresh period indication may be configured to indicate the determined channel dynamic range adjustment refresh period.

Split inference and/or collaborative intelligence may be performed. For example, machine vision analytics (e.g., classification, object detection, object tracking, etc.) may be accomplished, for example, with split deep neural networks (DNN). The split DNN may be physically apart from each other but communicating by transmitting intermediate data at a split point.

The amount of video and images consumed by machines may be rapidly increasing, for example, with the rise of machine learning technologies for vision applications (e.g., in domains like intelligent transportations, smart cities, intelligent content management, etc.). Vision tasks may use (e.g., demand) computations (e.g., heavy computations) and may be performed on cloud systems (e.g., rather than the limited devices capturing the source content, which may perform (e.g., require) the transmitting of the video content). The amount of source data may use performance compression, for example, to fit physical bandwidth and storage capacities (e.g., similar to traditional video transmission pipelines). Machine vision algorithms may not be sensitive to artifacts (e.g., artifacts associated with image and video codecs designed for human consumption), for example, if (e.g., when) applying lossy compression.

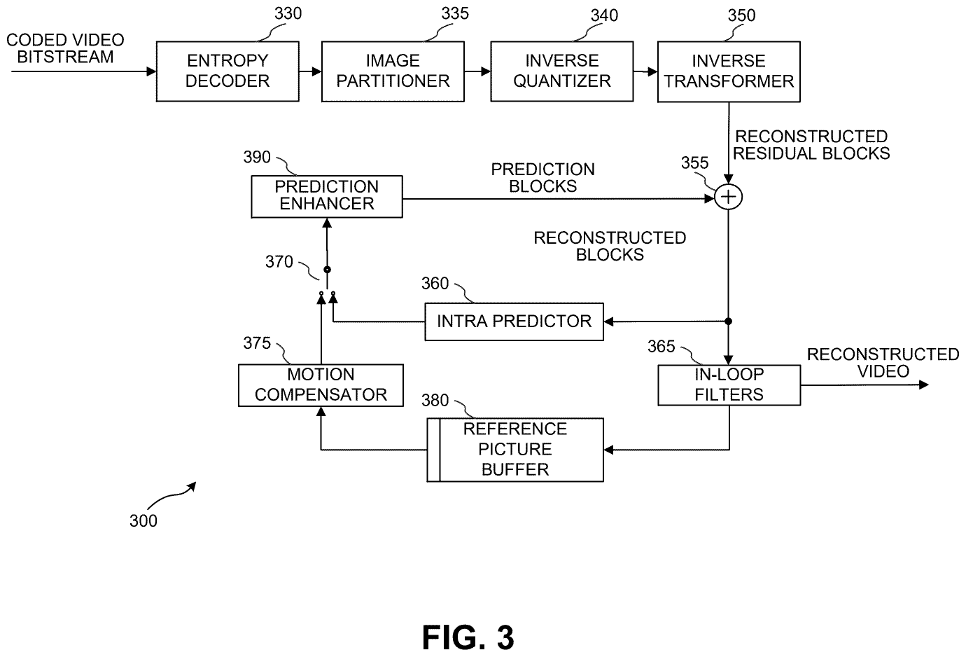

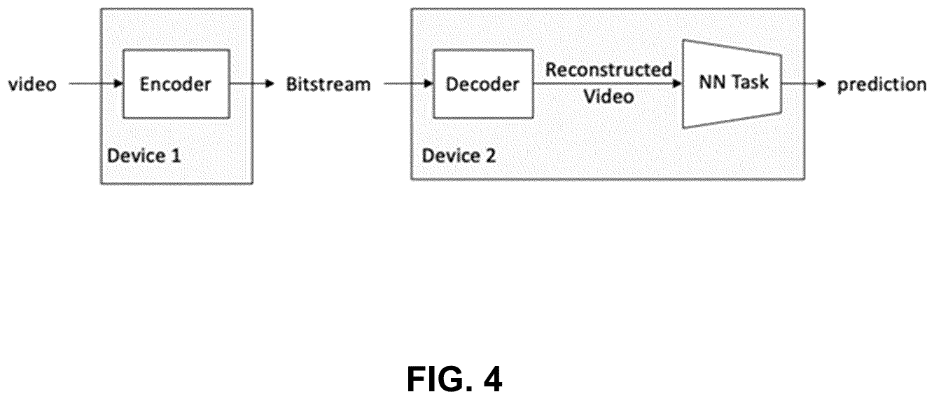

Remote analysis (e.g., efficient remote analysis) may be enabled and/or performed. Remote analysis may include compressing source videos, for example, using actions associated with downstream vision tasks rather than for human vision (e.g., actions optimized for downstream vision tasks rather than for human vision). A framework (e.g., shown in FIG. 4) may be used. The framework may include a framework associated with video coding for machines.

FIG. 4 illustrates an example video coding for machines pipeline.

The term video may include one or more image contents and/or video contents. The framework, actions, and/or descriptions provided herein may apply to both (e.g., image and video) types of content.

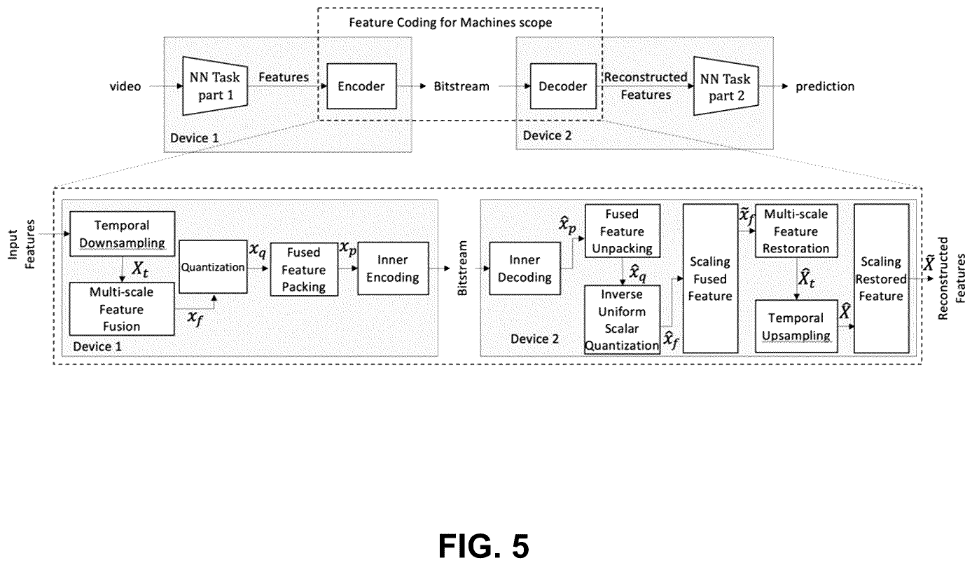

FIG. 5 illustrates an example of pipeline feature coding for machines. An example framework may include multiple parts (e.g., two parts) of the split DNN mode (e.g., NN Task Part 1 and NN Task Part 2 as shown in FIG. 5). The parts of the split DNN model (e.g., NN Task Part 1 and NN Task Part 2) may be run on different devices, e.g., NN Task Part 1 on a phone or camera and NN Task Part 2 on the network or cloud. Such splitting of the model may be used to offload (e.g., some of the) computations, for example, if (e.g., when) the device that captures or contains the source content is limited in terms of processing, memory, energy, etc. It can also be useful to transmit such features while protecting the privacy of the original content (e.g., because the original pixels are not directly coded). In this context, at the split point, intermediate data or features need to be transmitted to the remote machine to perform the second part of the model inference.

The device containing the source video may perform NN Task Part 1 to extract features. These features may be transmitted and analyzed remotely by NN Task Part 2. The data volume of the feature tensor(s) may be greater (e.g., usually much greater) than input data volume. A codec that efficiently reduces the size of the feature bitstream to enable the transmission over limited bandwidth networks may be introduced (e.g., configured). A video codec may have been configured (e.g., optimized) to natural scenes, graphic content, etc., in 2-dimensional input data for the human visual system. Such video codec may not have been designed to compress the computed features in a shape of 3 dimension (3D) over the first layers of a DNN for machine vision tasks. Compression methods for the intermediate feature tensors may be provided, for example, in the context of a split inference scenario.

FIG. 5 (e.g., at the zoomed-in dashed block) may illustrate example compression modules composing a feature coding for machines coding pipeline. Input features

$$X = {\{ {x}_{n} \}}_{n = 1}^{N}$$

may be compressed. N may be the number of feature tensors with 3-dimension (3D), e.g., from the NN Task Part 1. Feature coding for machines (FCM) encoder may drop some (e.g., every other) set of input feature tensors if temporal downsampling is enabled. The non-dropped feature input Xₜ at time t may be fed into the multi-scale feature fusion and fused into a (e.g., a single) tensor x_{f}. The multi-scale feature fusion may be a NN-based module that is trained offline to fuse and reduce (e.g., significantly reduce) the dimensions of the input tensors. At the feature conversion stage, the fused feature channels may be quantized with q-bit, tiled and packed onto a 2D frame xₚ. The order of the modules in the conversion stages may be switched (e.g., may be swappable). The packed frame with the quantized features xₚ may be encoded into video data, such as a bitstream.

On a remote server, the FCM inner decoder, e.g., the 2D video codec, may take video data, e.g., a bitstream, as an input and may reconstruct the tiled frame \hat{x}ₚ. The reconstructed tiled frame \hat{x}ₚ may be reshaped into 3D feature tensors \hat{x}_{q}, e.g., via fused feature unpacking module. The inverse uniform scalar quantization may be applied to \hat{x}_{q} to get \hat{x}_{f} in the range 0 to 1.0. Using \hat{x}_{f} as the input, the scaling fused feature module, which may be present (e.g., may only be present) at the decoder, may scale \hat{x}_{f} to have a standard deviation of 1 and a mean of 0. This may be known as Z-score normalization. The scaled \hat{x}_{f} may be re-scaled back, e.g., using transmitted statistical parameters of mean and standard deviation for the original x_{f}. Scaled \tilde{x}_{f} with the transmitted mean and standard deviation may be fed into the Multi-scale Feature Restoration module. The neural network-based restoration module may reconstruct the multiple feature tensors

$${\hat{X}}_{t} = {\{ {\hat{x}}_{t , n} \}}_{n = 1}^{N}$$

that correspond to the interface with the split point(s). If (e.g., when) the temporal upsampling module is enabled, the reconstructed \hat{X}ₜ may be buffered till the next \hat{X}ₜ₊₂ is reconstructed in order to estimate \hat{X}ₜ₊₁ with a bilinear interpolation. Regardless of the activation of upsampling, the output of the Temporal Upsampling, \hat{X}, may be scaled by the scaling module, e.g., Scaling Restored Feature. Scaling Restored Feature may be performed at the decoder (e.g., at the decoder only), using the transmitted global mean and standard deviation of X. The re-scaled feature tensors

$${\tilde{X}}_{t} = {\{ {\tilde{x}}_{n} \}}_{n = 1}^{N}$$

may be used as the input to the NN Task Part 2, e.g., to complete the inference of the machine task.

It may be assumed that the pre-trained NN-task-part-1 and NN-task-part-2 may not be trained with an entropy constraint on one or more intermediate features. For example, the loss function that drives the training may not include one or more (e.g., any) terms related to the potential size of the intermediate data to transmit at the split point. Unlike auto-encoders that introduce information bottleneck to properly train a network with respect to reconstruction quality and bitrate, one or more computer vision algorithms may be trained to maximize the accuracy (e.g., the accuracy only). A (e.g., each) feature map, also called channels, computed through a learned computer vision network may contribute to the end accuracy, whatever the coding cost.

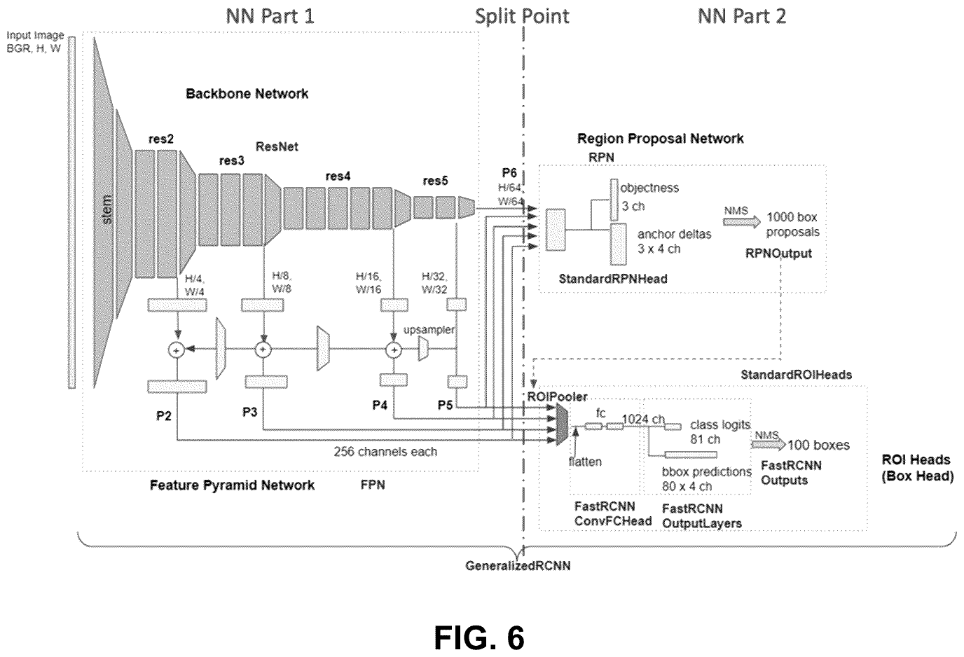

FIG. 6 illustrates example regions with convolutional neural network (RCNN) architecture. The P layers may include tensors of 256 channels (e.g., with different resolutions). FIG. 6 may show an example Faster-RCNN architecture. As shown in FIG. 6, the model may include a backbone that may generate feature tensors of different sizes (e.g., P2, P3, P4, P5, P6). The feature tensors (e.g., of different sizes) may be analyzed for tasks, for example, such as object detection and segmentation. In the split-inference context, a split point (e.g., split that separates NN-part-1 and NN-part-2 as shown in FIG. 5) may be considered (e.g., where the encoded and transmitted data corresponds to tensors X={x₁=P2, x₂=P3, x₃=P4, x₄=P5}.

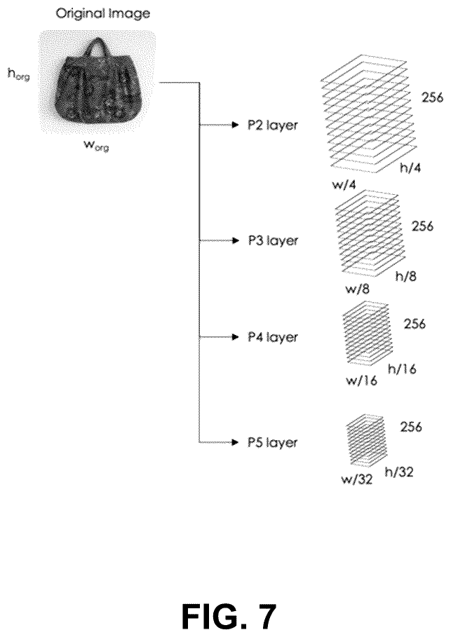

FIG. 7 illustrates example shapes tensors to transmit (e.g., considering the split point after the backbone network of a generalized R-CNN architecture). The tensors may include 256 channels for an input image. The tensors may include different resolutions (e.g., depending on the input resolution). The input resolution to the model may be different from the original image (e.g., size w_{org}×h_{org}), for example, due to rescaling and padding operations.

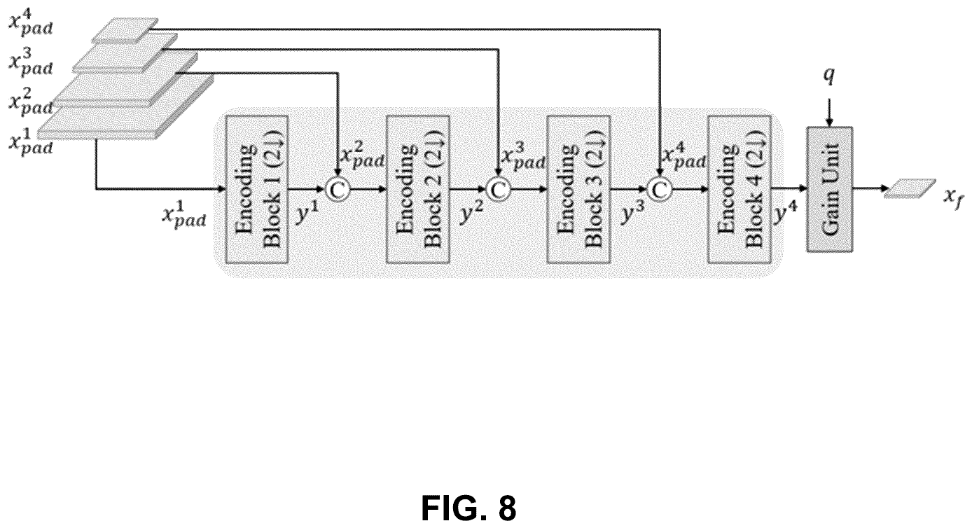

FIG. 8 illustrates an example shallow network architecture for a feature reduction module interfacing with faster R-CNN at feature pyramid network outputs P2, P3, P4, and P5. Extracted feature tensors out of the NN Part 1 in Faster R-CNN may be fed into a multi-scale feature fusion model (e.g., as shown in FIG. 8). In examples, P2, P3, P4, P5 may be represented by

$${x}_{pad}^{1} , {x}_{pad}^{2} , {x}_{pad}^{3} , {x}_{pad}^{4} ,$$

respectively. A feature tensor (e.g., each original feature tensor) may be padded (e.g., properly padded) before applying the convolutional layers, for example, because of a spatial shift by nature of the convolution operation.

As shown in FIG. 8, the set of feature tensors may be converted into a single feature tensor (e.g., with 320 channels, y⁴, for example, using convolutional layers with learned weights). A Gain Unit may adjust the scales of the feature tensor y⁴, for example, by multiplying each channel by a learned vector (e.g., out of 8 candidate vectors). The gain unit may output the reduced feature tensor x_{f}∈ [symbol] ^{C}^{_{f}}^{×H}^{_{f}}^{×W}^{_{f}} (e.g., where C_{f}=320 and H_{f}×W_{f} may include the spatial resolution of the feature tensor). The index of the vector (e.g., q) as input to the Gain Unit may be heuristically selected or fixed.

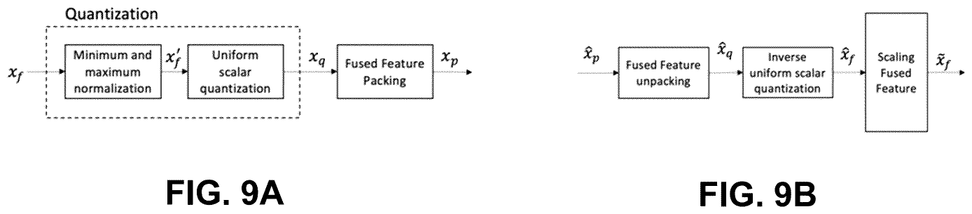

FIG. 9A illustrates an example feature conversion, and FIG. 9B illustrates an example inverse feature conversion in FCM. A fused feature packing module may reshape (e.g., conduct reshaping) 3D tensors into 2D frames xₚ (e.g., followed by quantization), for example, to utilize one or more standard video codecs to encode the reduced feature tensor x_{f} in 3 dimensions. FIG. 9A illustrates an example feature conversion including (e.g., consisting) of the normalization followed by the uniform scalar quantization and fused feature packing. FIG. 9B illustrates an example inverse conversion including (e.g., consisting) fused feature unpacking followed by the inverse uniform scalar quantization and scaling fused feature module. The order between the quantization and fused feature packing may be switched (e.g., may be swappable).

For an input feature tensor x_{f} (e.g., each input feature tensor) fused by the multi-scale feature fusion module, the minimum and maximum values of the feature tensors, x_{f,min} and x_{f,max} may be computed and may be used to normalize the feature values between 0 and 1 according to Eq. 1.

$${x}_{f}^{′} = max ( min ( \frac{{x}_{f} - {x}_{f , min}}{{x}_{f , max} - {x}_{f , min}} , 0 ) , 1 ) \qquad Eq . 1$$

The q-bit uniform scalar quantization may be applied to x′ (e.g., before packing the feature channels onto a 2D frame) to use as an input to a codec, e.g., according to Eq. 2.

$${x}_{q} = round ( {x}_{f}^{′} \times ( {2}^{q} - 1 ) ) \qquad Eq . 2$$

The rounding operation may include round( ), for example, which may include a rounding operation to the nearest integer value.

For the fused feature packing, the frame resolution Hₚ and Wₚ may be computed such that the shape of the packed frame becomes wide rectangular, for example, as much as possible by which C_{f} is divided properly in width and height and multiplied by W_{f} and H_{f}, respectively.

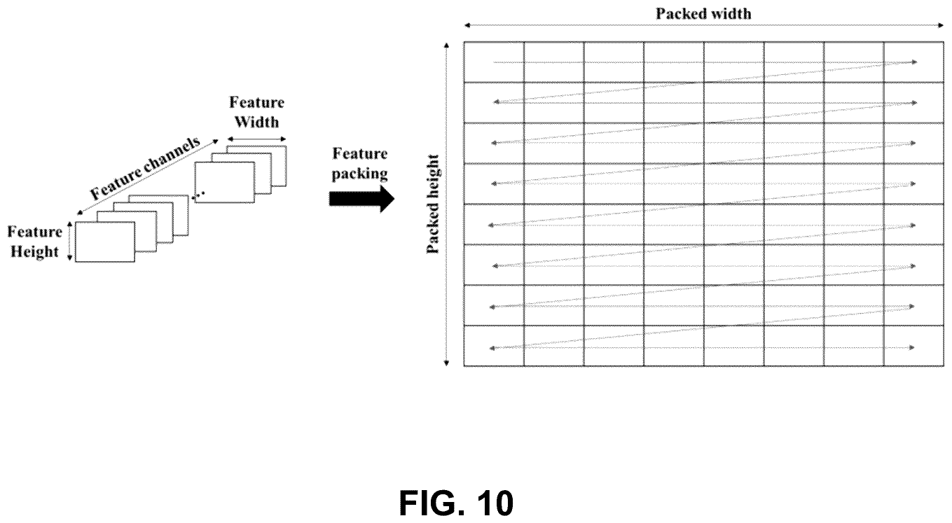

FIG. 10 illustrates an example of tiled feature channels into a packed frame. For example, FIG. 10 may present the final packed frame xₚ∈ [symbol] ^{H}^{ₚ}^{×W}^{ₚ} out of C_{f}.

After the conversion process, the frame xₚ represented in q-bit integer may be fed into the video codec. Other necessary information for the decoding process, such as mean and standard deviation parameters of the original features for scaling operations, feature tensor sizes, etc., may be coded and/or may be added to the video data (e.g., the bitstream). The decoding process may correspond to the inverse scaling and packing operations of the encoder in inverse order, for example, using the parsed information from the video data (e.g., the bitstream). Additional scaling operations may be applied (e.g., may only be applied) at the decoder as shown in FIG. 5 and/or FIG. 9B.

The channel dynamic range of the feature channels may be adjusted (e.g., using a non-linear function after the minimum and maximum normalization processes). Feature values may be transformed over non-linear function per channel such that adjusted feature channels may be coded (e.g., efficiently coded) in terms of rate and task accuracy. For example, the non-linear function (e.g., the logit function that is the quantile function associated with the standard logistic distribution) with scale parameters as slope adjustment coefficients may take x′_{f} as the input and may output the feature channels with one or more feature data ranges (e.g., one or more new feature data ranges). Different scale parameter(s) for a (e.g., each) channel may be optimized, e.g., during the encoding process. The feature channels with adjusted data range over non-linear function may be quantized with q-bit and packed onto a 2D frame to be fed into the inner video codec. The optimized scales for the non-linear function may be (e.g., may also be) quantized and coded in the output bitstream. The optimized scales for the decoder may be different from the ones optimized and used at the encoder. For the decoding, the inverse of the non-linear function (e.g., the sigmoid function) with the transmitted scale parameters may be applied to the reconstructed feature tensor \hat{x}_{f}. The output of the inverse operation may bring back the non-linear transformed data ranges to the ranges (e.g., the original ranges) with compression noise. For videos, the scale parameters may be updated (e.g., updated periodically), for example, every intra frame period. The refresh period may be coded in the bitstream or may be aligned with other refresh period coded for other tools, such as scaling fused feature or scaling restored feature methods. In examples, a (e.g., each) quantized scale parameter may be coded with a fixed number of bits (e.g., 3 bits) in the bitstream. In examples, the quantized scales may be coded with run-length coding in the bitstream. In examples, the quantized scales may be coded (e.g., may also be coded) adaptively following a designed syntax structure as described herein. The examples described herein may be incorporated (e.g., may adaptively be incorporated) with one or more other coding tools executed before and/or after the algorithm described herein in the encoder and/or the decoder.

Feature reduction and restoration actions in the coding pipeline (e.g., if/when compressing intermediate features of machine task algorithms) may have to adapt to interface with a (e.g., any) split neural network(s) (NNs), for example, because there may be a variety (e.g., a large variety) of task vision models with (e.g., many) potential split points (e.g., yielding various intermediate feature characteristics: shapes, sizes, and distribution of the values). Data dimension reduction and restoration (e.g., efficient data dimension reduction and reduction) on the intermediate feature tensor(s) may be provided. For example, the data dimension reduction and restoration (e.g., efficient data dimension reduction and reduction) on the intermediate feature tensor(s) may interface (e.g., adaptively interface) with one or more split points. The dimension of the intermediate features may surpass the size of the input frame (e.g., the original input frame). One or more (e.g., several) NN-based multi-scale feature fusion and restoration models, referred to as reduction and restoration methods, may be adopted. The NN-based multi-scale feature fusion and restoration models may be dedicated to a (e.g., each) considered split point and machine vision network under test. x_{f} may correspond to the activation output of the last layer of the NN Part 1 of the split model, which may follow (e.g., may typically follow) Gaussian or Laplacian density functions.

During the conversion process, e.g., consisting of normalization, quantization, and/or packing, the minimum and maximum normalization may be applied, e.g., followed by a uniform scalar quantization to x_{f} to form a 2D frame of features with integer values. After the minimum and maximum normalization, x′_{f} may be quantized and/or may be scaled (e.g., may be uniformly quantized and scaled) to integer values without considering the characteristics of input content, task network, split point, and/or the reduction and restoration method in FCM. Scaling and quantizing x_{f} adaptively that corresponds to one or more (e.g., all) the listed factors, especially for the FCM codec pursuing the low delay compression for machine vision inference, may be challenging. For example, it may be unpractical to optimize the coding tools, such as quantization for the end task, by examining the inference with NN Part 2 during encoding time in the context of split inference.

As described herein, x_{f} may be transformed using one or more non-linear functions with scale parameters, e.g., before the uniform scalar quantization, such that the size of the coded bitstream is minimized while keeping up the task accuracy. The scale parameters may be optimized for an (e.g., each) input feature channel during encoding time. At the decoder, the transmitted quantized scale parameters may be used by the inverse non-linear functions to adaptively re-map the reconstructed feature \hat{x}_{f} to the original range of the feature values with compression noise. As further described herein, one or more scale parameters may be coded.

As shown in FIG. 8, learned NN-based reduction and restoration for different task networks and split points may be adopted. The reduction and restoration may include the scaling (e.g., Gain Unit) and inverse scaling computation (e.g., Inverse Gain Unit) on the feature tensor (e.g., at the last part and the first part of the modules, respectively). The Gain Unit may be introduced (e.g., originally introduced) to support the NN-based image compression for multivariate operation. The intention of adopting the Gain Unit in the NN-based restoration and reduction module in FCM may be similar to the original, expecting that the fused features are adaptively scaled to correspond to the desired size of bitstream without updating the rest of the weights for the convolutional layers. Actual bitstream size may be determined over the compression process within the inner codec in FCM. The learned weight in an offline manner may limit the gain unit to adapt to the input, split point, and/or task-dependent feature tensor x_{f}.

Learnable scale and shift parameters of affine transform (e.g., linear function) may adjust the channel-wise dynamic range of reduced feature tensor, e.g., in order to save bits while preserving task accuracy. To bring back the channel dynamic ranges (e.g., the original channel dynamic ranges) at the decoder, inverse scale and shift parameters may be signaled and applied to reconstructed feature channels during the inverse conversion process (e.g., though compression noise may exist). Eq. (3) may illustrate the channel dynamic range adjustment computation process in the encoder side with optimized scale α_{enc,i} and shift δ_{enc,i} parameters:

$${y}_{f , i} = {α}_{enc , i} \times {x}_{f , i}^{′} + {δ}_{enc , i} \qquad Eq . 3$$

i={1, 2, . . . , C_{f}} may be the channel index. The updated feature channels y_{f,i} may be quantized (e.g., may be uniformly quantized) to q-bit integer values to be fed into the inner encoder. For the inverse process corresponding to the Eq. 3, the quantized scales \tilde{α}_{dec,i} and shift \tilde{δ}_{dec,i} parameters may be transmitted to the decoder. The Eq. 4 may be applied to the reconstructed ŷ_{f,i} as the output of the inverse uniform scalar quantization.

$${\hat{x}}_{f , i} = \frac{( {\hat{y}}_{f , i} - {\tilde{δ}}_{dec , i} )}{{\tilde{a}}_{dec , i}} \qquad Eq . 4$$

For example, the quantized \tilde{α}_{dec,i} and \tilde{δ}_{dec,i} may be coded in 10 bits each, and the total number of pairs of values may be equal to the number of channels of the fused feature tensor C_{f}, yielding a quite large amount of overhead bits. The overhead relative to the total size of the bitstream may be high (e.g., may be especially high) in the case of single image scenarios, e.g., where the parameters may not be transmitted once and be valid for multiple frames. Optimal scale and shift parameters may be found. As an example, an online learning-based approach may be introduced with a non-linear function to update (e.g., properly update) the parameters through back-propagation of computed gradients.

In examples, the fused feature rescaling method at the encoder may transmit a scale parameter β to the decoder and multiply the parameter to the standard deviation (e.g., the original standard deviation) of the fused feature tensor σₓ_{_{f}} during the Scaling Fused Feature computation illustrated in FIG. 9B.

The scaling fused feature method may compute \tilde{x}_{f} in accordance with Eq. 5.

$${\tilde{x}}_{f} = \frac{{\hat{x}}_{f} - {μ}_{{\hat{x}}_{f}}}{{σ}_{{\hat{x}}_{f}}} \times {σ}_{{x}_{f}} + {μ}_{{x}_{f}} \qquad Eq . 5$$

μ_{\hat{x}}_{_{f}} and σ_{\hat{x}}_{_{f}} may be the mean and standard deviation of the reconstructed feature tensor, \hat{x}_{f}. μₓ_{_{f}} and σₓ_{_{f}} may represent the mean and standard deviation of the fused feature tensor x, from the encoder. To properly complete the computation of Eq. 5, μₓ_{_{f}} and σₓ_{_{f}} may be coded in video data (e.g., a bitstream). The fused feature rescaling method may rescale σₓ_{_{f}}, e.g., by multiplying β that is also transmitted from the encoder. The updated computation may be in accordance with Eq. 6.

$${\tilde{x}}_{f} = \frac{{\hat{x}}_{f} - {μ}_{{\hat{x}}_{f}}}{{σ}_{{\hat{x}}_{f}}} \times ( {σ}_{{x}_{f}} \times β ) + {μ}_{{x}_{f}} \qquad Eq . 6$$

Parameters σₓ_{_{f}} and μₓ_{_{f}} may be signaled from the encoder to examine Eq. 5, e.g., for the scaling fused feature method. The scaled standard deviation β×σₓ_{_{f}} may be transmitted based on the encoder optimization method. The current syntax and computation algorithm with Eq. 5 may become viable to compute Eq. 6. The scale β may be computed (e.g., no specific rule to compute the scale) and may be selected (e.g., heuristically selected). Bit savings may not be achieved because the rescaling method may be applied to the decoder side (e.g., the decoder side only).

A normalization method with non-linear function may be configured and may alternate to the minimum and maximum normalization as illustrated in FIG. 9A. Dynamic range adjustment may be performed on a channel level using a non-linear model(s) as described herein.

An absolute maximum value, absmaxₓ_{_{f}}, of the fused feature tensor x_{f} may be found and may normalize the fused feature, e.g., such that the range of the normalized values falls into between 0 and 1 in accordance with Eq. 7.

$${x}_{f}^{′} = \frac{{x}_{f} + abs {max}_{{x}_{f}}}{2 \times abs {max}_{{x}_{f}}} \qquad Eq . 7$$

The output of the non-linear function using

$${x}_{f}^{′}$$

as input may be quantized (e.g., uniformly quantized) into q-bit integer values. The computation may be simplified based on the quantization, and the non-linear transform process may output the values between 0 and 1. If (e.g., when) the non-linear transform employs a logit function with a slope adjustment coefficient k, the input

$${x}_{f}^{′}$$

may be rescaled with the values corresponding to −1 and 1 at the output of the logit transform. The inverse function of the logit transform may be the sigmoid function. The corresponding values may be computed in accordance with Eq. 8.

$${logit}_{min} = \frac{1}{( 1 + {e}^{1 / k} )} and {logit}_{max} = \frac{1}{( 1 + {e}^{- 1 / k} )} \qquad Eq . 8$$

The rescaled features

$${x}_{f}^{″}$$

may be computed in accordance with Eq. 9.

$${x}_{f}^{″} = {x}_{f}^{′} \times ( {logit}_{max} - {logit}_{min} ) + {logit}_{min} \qquad Eq . 9$$

The non-linear transformed feature tensor may be computed in accordance with Eq. 10.

$${y}_{f} = \frac{1}{2} ( 1 - k \times ln ( \frac{1}{{x}_{f}^{″}} - 1 ) ) \qquad Eq . 10$$

k may be selected among {3,4,5,6} in the encoder and may be coded on two bits in the video data (e.g., the bitstream).

In the decoder, ŷ_{f} may be the inverse quantized feature values, e.g., which may be stretched between −1 to 1. As an inverse computation of the non-linear transform,

$${\hat{x}}_{f}^{″}$$

may be computed in accordance with Eq. 11.

$${\hat{x}}_{f}^{″} = \frac{1}{( 1 + {e}^{- {\hat{y}}_{f} / k} )} \qquad Eq . 11$$

Using the k and absmaxₓ_{_{f}} derived from parsed syntax in the video data (e.g., the bitstream), \hat{x}_{f} may be computed with a linear scaling operation in accordance with Eq. 12 and Eq. 13.

$${\hat{x}}_{f}^{′} = \frac{{\hat{x}}_{f}^{″} - {logit}_{min}}{{logit}_{max} - {logit}_{min}} \qquad Eq . 12$$

$${\hat{x}}_{f} = 2 \times abs {max}_{{x}_{f}} \times {\hat{x}}_{f}^{′} - abs {max}_{{x}_{f}} \qquad Eq . 13$$

The method may choose one k={3,4,5,6} applied to over feature channels. Adaptation to different variations of dynamic range for a (e.g., each) channel may not occur. Unnecessary computation, e.g., multiple times of normalization, may be simplified without the minimum and maximum values transmitted from the encoder.

As described herein, a channel dynamic range adjustment method via non-linear function that may need (e.g., may only require) an adjustment parameter (e.g., a single adjustment parameter such as a scale parameter) for a (e.g., each) fused feature channel may be configured. The scales may work as slope adjustment coefficients for the non-linear function and may be optimized towards a tradeoff between rate and distortion on the reconstructed feature tensors, e.g., considering the bit costs and degradations induced by the inner codec. Separate adjustment parameters (e.g., slope adjustment parameters, scale parameters, and/or the like) for the decoder may be optimized with respect to the feature reconstruction process. The overhead bits for transmitting the optimized scales to the decoder may be reduced as described herein.

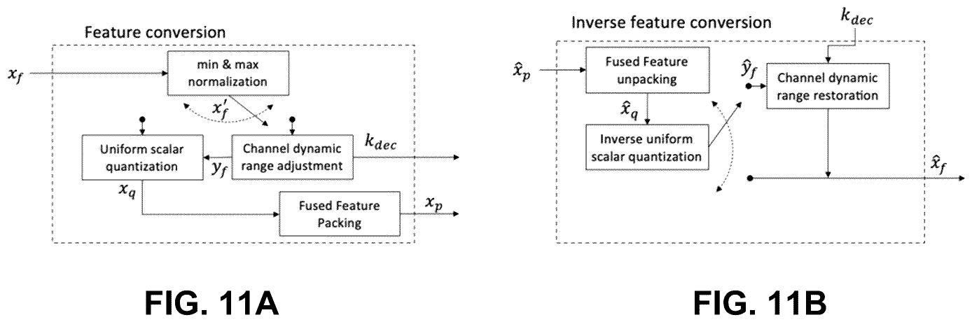

Channel dynamic range adjustment may be performed via non-linear functions. FIG. 11A illustrates an example of conversion with the channel dynamic range adjustment in an encoder. FIG. 11B illustrates an example of conversion with the channel dynamic range restoration in a decoder.

FIG. 11A illustrates an example of conversion that may include a channel dynamic range adjustment (CDRA) (e.g., for the encoder). FIG. 11B illustrates an example conversion that may include a channel dynamic range restoration (CDRR) (e.g., for the decoder). The output of the feature reduction x_{f} may be linearly normalized with a minimum x_{f,min} and a maximum x_{f,max} values of x_{f}. The normalized feature tensor

$${x}_{f}^{′} = \frac{{x}_{f} - {x}_{f , min}}{{x}_{f , max} - {x}_{f , min}}$$

may be present between 0 and 1. If (e.g., when) the method described herein is enabled, a (e.g., each) channel of the normalized feature tensor with index i, x′_{f,i} may be transformed over a non-linear function. For the non-linear transform function, the scale parameters may be employed as slop adjustment coefficients. The algorithm using an example non-linear function and/or logit transform herein is an example and may not be limited to a specific non-linear function.

In examples, before applying the non-linear transform,

$${x}_{f , i}^{′}$$

may be rescaled with

$${l}_{min , i} = \frac{1}{( 1 + {e}^{1 / {k}_{enc , i}} )} and {l}_{max , i} = \frac{1}{( 1 + {e}^{- 1 / {k}_{enc , i}} )} by Eq . 12.$$

$${x}_{f , i}^{″} = {x}_{f , i}^{′} \times ( {l}_{max , i} - {l}_{min , i} ) + {l}_{min , i} \qquad Eq . 12$$

k_{enc,i} may be the scale parameter for i-th channel at the encoder. The value k_{enc,i} may be presented in floating point precision if the implementation device allows it. Otherwise, k_{enc,i} may be an integer value.

The channel dynamic range of

$${x}_{f , i}^{″}$$

may be non-linearly transformed in accordance with Eq. 13.

$${y}_{f , i} = \frac{1}{2} ( 1 - {k}_{enc , i} \times ln ( \frac{1}{{x}_{f , i}^{″}} - 1 ) ) \qquad Eq . 13$$

A non-linearly transformed feature tensor

$${y}_{f} = {\{ {y}_{f , i} \}}_{i = 1}^{{C}_{f}}$$

may be quantized (e.g., may uniformly be quantized) to q-bit integer values and packed into 2D frame. To perform the inverse process of the non-linear transform at the decoder,

$${k}_{enc} = {\{ {k}_{enc , i} \}}_{i = 1}^{{C}_{f}}$$

may be coded in video data (e.g., in the bitstream). If integer values of k_{enc} are used in the encoder, the k_{dec} parsed scales for the decoder may be the same integer values as k_{enc}. If the values k_{enc} in floating point precision are used in the encoder, the k_{dec} parsed scales for the decoder may be the quantized values of k_{enc}, e.g., with rounding operation to the nearest integer value. Regardless of the data type of k_{enc}, k_{dec} may be optimized (e.g., separately optimized). It may become different from k_{enc} and may minimize reconstructed feature errors for the decoder operation.

In the decoder, the reconstructed frame with features, \hat{x}ₚ, may be unpacked to a 3D feature tensor \hat{x}_{q}, followed by the inverse uniform scalar quantization if the method described herein is not enabled. If the method described herein is enabled, the output of the inverse uniform scalar quantization ŷ_{f} may be used as an input to the channel dynamic range restoration computation with parsed k dec. For example, if (e.g., when) the logit transform is used for the non-linear function at the encoder, the inverse function may be a sigmoid transform. The inverse transformed feature channel with the sigmoid function may be computed in accordance with Eq. 14.

$${\hat{x}}_{f , i}^{″} = \frac{1}{( 1 + {e}^{- {\hat{y}}_{f , i} / {k}_{dec , i}} )} \qquad Eq . 14$$

To bring back the inverse-transformed feature channel to the valid feature channel dynamic range, it may be linearly scaled with

$${\hat{l}}_{min , i} = \frac{1}{( 1 + {e}^{1 / {k}_{dec , i}} )} and {\hat{l}}_{max , i} = \frac{1}{( 1 + {e}^{- 1 / {k}_{dec , i}} )}$$

in accordance with Eq. 15.

$${\hat{x}}_{f , i} = \frac{{\hat{y}}_{f , i} - {\hat{l}}_{min , i}}{( {\hat{l}}_{max , i} - {\hat{l}}_{min , i} )} \qquad Eq . 15$$

Due to the scaling fused feature module adopted (e.g., as shown in FIG. 9B), inverse minimum and maximum normalization may be skipped (e.g., may not be needed and/or may not be required) at the decoder. Eq. 15 may be used (e.g., directly used) as the input to the scaling fused feature module as the input.

The coded scale parameters k dec may be updated one or more (e.g., every) periods of L by transmitting the in the video data (e.g., the bitstream). The L may be aligned (e.g., may also be aligned) with Intra coding period or the refresh period of other tools, such as the scaling fused feature method.

Signaling information may be configured. For example, an indication, such as a flag, transmitted in Feature Sequence Parameter Set (FSPS) may be used to enable the method described herein. In addition to and/or alternatively, the refresh period may be (e.g., may also be) indicated in the FSPS as shown in Table 1.

TABLE 1
Example feature sequence parameter set (FSPS)

| | Descriptor |
|---|---|
| feat_seq_parameter_set_rbsp ( ) { | |
| fsps_feat_seq_parameter_set_id | |
| num_ori_feat_layers | |
| for (i = 0; i <= num_feature_layers; i++) { | |
| ori_feat_wid[i] | |
| ori_feat_hei[i] | |
| num_ori_feat_chan[i] | |
| } | |
| fused_feat_wid | |
| fused_feat_hei | |
| fsps_number_of_fused_feature_channels | u(16) |
| inner_decoding_bypass_flag | |
| if( !inner_decoding_bypass_flag ) { | |
| feat_inner_decoder_info( ) | |
| } | |
| dequant_bypass_flag | |
| unpacking_bypass_flag | |
| feat_restoration_bypass_flag | |
| if( !feat_restoration_bypass_flag ) | |
| feat_restoration_info( ) | |
| } | |
| temporal_upsampling_enable_flag | u(1) |
| restored_feat_refine_flag | u(1) |
| fused_feat_refine_flag | u(1) |
| fsps_channel_dynamic_range_adjustment_flag | u(1) |
| if (restored_feat_refine_flag ) { | |
| restored_feat_refine_refresh_period | u(8) |
| } | |
| if(fused_feat_refine_flag) { | |
| fused_feat_refine_refresh_period | u(8) |
| } | |
| if(fsps_channel_dynamic_range_adjustment_flag) { | |
| fsps_channel_dynamic_range_adjustment_refresh_period | u(8) |
| } | |
| rbsp_trailing_bits( ) | |
| } | |

fsps_number_of_fused_feature_channels may specify the number of fused feature channels of x_{f}. The number of fused feature channels may be inferred by which the frame resolution of the coded features parsed from the inner decoder is divided by fused_feat_wid×fused_feat_hei. Parsing this information from the FSPS, e.g., without waiting for the inner decoder operation, may be beneficial. If fsps_number_of_fused_feature_channels is not coded, the method described herein may derive the number of fused feature channels upon the frame resolution of the coded features being available. The derived number of fused feature channels may be used to parse the scale parameters (e.g., later).

fsps_channel_dynamic_range_adjustment_flag may enable the channel dynamic range adjustment decoding operation.

A channel dynamic range adjustment refresh period indication, such as fsps_channel_dynamic_range_adjustment_refresh_period may specify the refresh period at which the scaling parameters for the channel dynamic range adjustment are transmitted. If fsps_channel_dynamic_range_adjustment_refresh_period is equal to 0 and fsps_channel_dynamic_range_adjustment_flag is true (e.g., equal to 1), the scale parameters may be coded (e.g., may only be coded at the very first picture order count (POC) or if (e.g., when) the nal_unit_type corresponds to an instantaneous decoding refresh (IDR) picture. For example, (e.g., by default), fsps_channel_dynamic_range_adjustment_refresh_period may be set to 0. One or more codecs (e.g., used as an inner codec) may include different syntax elements to indicate an IDR picture, e.g., depending on the scenarios supported by a standard. In examples, the coded slice of an IDR picture may be identified as such if (e.g., when) the nal_unit_type is equal to 5. In examples, two different types of nal_unit_type for IDR pictures may be defined: an IDR with random access decodable leading (e.g., IDR_W_RADL) picture and an IDR with no leading pictures (e.g., IDR_N_LP). The condition for the IDR described herein may apply to one or more (e.g., both) examples. If fsps_channel_dynamic_range_adjustment_refresh_period is greater than 0 and fsps_channel_dynamic_range_adjustment_flag is true (e.g., equal to 1), the update on the scale parameters may be expected if (e.g., when) the (POC % fsps_channel_dynamic_range_adjustment_refresh_period)==0. If fsps_channel_dynamic_range_adjustment_refresh_period is not coded, it may be aligned with intra period or another refresh period may exist (e.g., may already exist) in FSPS, such as fused_feat_refine_refresh_period.

Adjustment parameters for the channels, such as scale parameters

$${k}_{dec} = {\{ {k}_{dec , i} \}}_{i = 1}^{fsps\_number \_of \_fused \_feature \_channels}$$

in integer values, may be coded in Feature Picture Parameter Set (FPPS). For example, if there are few cases that the optimized k_{dec} is converged to less than 3, the range of k_{dec} may be constraint to between 3 and 10 to code in 3 bits. In that case, the actual symbol, e.g., referred to as fpps_cdra_scale_minus_3, to code may be represented by s_{dec}=k_{dec}−3.

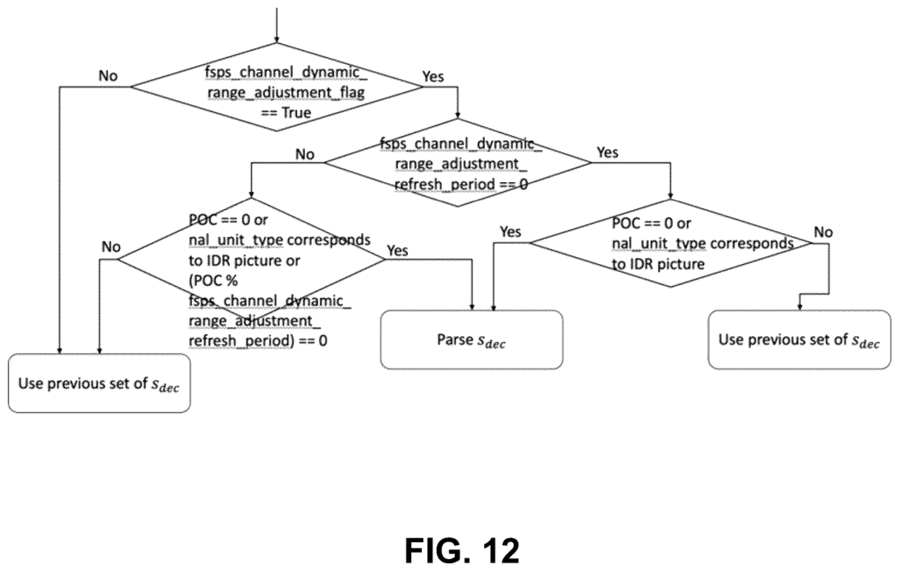

Following the condition of fsps_channel_dynamic_range_adjustment_refresh_period and signaling s_{dec} as depicted in FIG. 12, one or more examples to code s_{dec} in video data (e.g., the bitstream) may exist. FIG. 12 illustrates an example flowchart to parse s_{dec}.

In examples, a (e.g., each) scaling parameter in s_{dec} in 3 bits may be coded as shown in Table 2.

TABLE 2
An example of signaling fpps_cdra_scale_minus_3

| | Descriptor |
|---|---|
| feature_pic_parameter_set_rbsp( ) { | |
| fpps_feat_pic_parameter_set_id | |
| fpps_feat_seq_parameter_set_id | |
| if( !dequant_bypass_flag ) { | |
| ... | |
| } | |
| if( !unpacking_bypass_flag ) { | |
| ... | |
| } | |
| ... | |
| update_channel_dynamic_range_adjustment_parameters = 0 | |
| if (fsps_channel_dynamic_range_adjustment_refresh_period == 0) { | |
| if ((POC == 0 or nal_unit_type == IDR picture) { | |
| update_channel_dynamic_range_adjustment_parameters = 1 | |
| } | |
| else { | |
| if ( (POC == 0 or nal_unit_type == IDR picture or | |
| (POC % fsps_channel_dynamic_range_adjustment_refresh_period) == 0) { | |
| update_channel_dynamic_range_adjustment_parameters = 1 | |
| } | |
| if(fsps_channel_dynamic_range_adjustment_flag and | |
| update_channel_dynamic_range_adjustment_parameters == 1) { | |
| for (i = 0 ; i < fsps_number_of_fused_feature_channels; i++) { | |
| fpps_cdra_scale_minus_3[i] | u(3) |
| } | |
| } | |
| rbsp_trailing_bits( ) | |
| } | |

fpps_cdra_scale_minus_3[i] plus 3 may specify the integer scale value for the i-th feature channel.

3 bits may be assigned (e.g., equally assigned) for a (e.g., each) scale parameter. In examples, it may be inefficient to equally assign 3 bits for a (e.g., each) scale parameter, if (e.g., when) there is a scale value that occurs more than half of the fsps_number_of_fused_feature_channels. s_{dec} may be coded following the syntax shown in Table 3.

TABLE 3
Another example of signaling most_probable_scale, and fpps_cdra_scale_minus_3

| | Descriptor |
|---|---|
| feature_pic_parameter_set_rbsp( ) { | |
| fpps_feat_pic_parameter_set_id | |
| fpps_feat_seq_parameter_set_id | |
| if( !dequant_bypass_flag ) { | |
| ... | |
| } | |
| if( !unpacking_bypass_flag ) { | |
| ... | |
| } | |
| ... | |
| update_channel_dynamic_range_adjustment_parameters = 0 | |
| if (fsps_channel_dynamic_range_adjustment_refresh_period == 0) { | |
| if (POC == 0 or nal_unit_type == IDR picture) { | |
| update_channel_dynamic_range_adjustment_parameters = 1 | |
| } | |
| else { | |
| if ( (POC == 0 or nal_unit_type == IDR picture or | |
| (POC % fsps_channel_dynamic_range_adjustment_refresh_period) == 0) { | |
| update_channel_dynamic_range_adjustment_parameters = 1 | |
| } | |
| if(fsps_channel_dynamic_range_adjustment_flag and | |
| update_channel_dynamic_range_adjustment_parameters == 1) { | |
| fpps_cdra_most_probable_scale_minus_3 | u(3) |
| for (i = 0 ; i < fsps_number_of_fused_feature_channels; i++) { | |
| fpps_cdra_mps_flag | u(1) |
| if ( !fpps_cdra_mps_flag) { | |
| fpps_cdra_scale_minus_3[i] | u(3) |
| } | |
| } | |
| } | |
| rbsp_trailing_bits( ) | |
| } | |

A probable channel dynamic range adjustment indication may indicate a default channel dynamic range adjustment parameter value (e.g., a default channel dynamic range adjustment parameter value). For example, probable channel dynamic range adjustment indication such as fpps_cdra_most_probable_scale_minus_3 plus 3 may specify the scale value that occurs (e.g., occurs the most) among the scales.

fpps_cdra_mps_flag may be a flag indicating if the scale for i-th channel is equal to the fpps_cdra_most_probable_scale_minus_3. If (e.g., when) fpps_cdra_mps_flag is equal to 1, the scale value for i-th channel may be fpps_cdra_most_proable_scale_minus_3+3. If fppps_cdra_mps_flag is equal to 0, the scale for i-th channel may be different from fpps_cdra_most_probable_scale_minus_3+3.

fpps_cdra_scale_minus_3[i] plus 3 may specify the integer scale value for the i-th feature channel.

Table 4 shows the other example that would save more bits if (e.g., when) there is one scale parameter for one or more (e.g., all) the channels.

TABLE 4
The other example of signaling most_probable_scale,
single_scale_flag and fpps_cdra_scale_minus_3

| | Descriptor |
|---|---|
| feature_pic_parameter_set_rbsp( ) { | |
| fpps_feat_pic_parameter_set_id | |
| fpps_feat_seq_parameter_set_id | |
| if( !dequant_bypass_flag ) { | |
| ... | |
| } | |
| if( !unpacking_bypass_flag ) { | |
| ... | |
| } | |
| ... | |
| update_channel_dynamic_range_adjustment_parameters = 0 | |
| if (fsps_channel_dynamic_range_adjustment_refresh_period == 0) { | |
| if ((POC == 0 or nal_unit_type == IDR picture) { | |
| update_channel_dynamic_range_adjustment_parameters = 1 | |
| } | |
| else { | |
| if ( (POC == 0 or nal_unit_type == IDR picture or | |
| (POC % fsps_channel_dynamic_range_adjustment_refresh_period) == 0) { | |
| update_channel_dynamic_range_adjustment_parameters = 1 | |
| } | |
| if(fsps_channel_dynamic_range_adjustment_flag and | |
| update_channel_dynamic_range_adjustment_parameters == 1) { | |
| fpps_cdra_most_probable_scale_minus_3 | u(3) |
| fpps_cdra_single_scale_flag | u(1) |
| if (!fpps_cdra_single_scale_flag) { | |
| for (i = 0 ; i < fsps_number_of_fused_feature_channels; i++) { | |
| fpps_cdra_mps_flag | u(1) |
| if ( !fpps_cdra_mps_flag) { | |
| fpps_cdra_scale_minus_3[i] | u(3) |
| } | |
| } | |
| } | |
| } | |
| rbsp_trailing_bits( ) | |
| } | |

For example, a probable channel dynamic range adjustment indication such as fpps_cdra_most_probable_scale_minus_3 plus 3 may specify a scale value that occurs (e.g., most dominantly occurs) among the scales.

A common channel dynamic range adjustment indication may indicate whether to use a common channel dynamic range adjustment parameter value for channels associated with the feature tensor. For example, a common channel dynamic range adjustment indication such as fpps_cdra_single_scale_flag may be a flag indicating if there is one scale value (e.g., only one scale value) used for one or more (e.g., all) channels. If fpps_cdra_single_scale_flag is 1, fpps_cdra_most_probable_scale_minus+3 may be the one for one or more (e.g., all) channels. If fpps_cdra_single_scale_flag is 0, the scale for a (e.g., each) channel may be parsed with the following syntax.

fpps_cdra_mps_flag may be a flag indicating if the scale for i-th channel is equal to the fpps_cdra_most_probable_scale_minus_3. If (e.g., when) fpps_cdra_mps_flag is equal to 1, the scale value for i-th channel may be fpps_cdra_most_proable_scale_minus_3+3. If fppps_cdra_mps_flag is equal to 0, the scale for i-th channel may be different from fpps_cdra_most_probable_scale_minus_3+3.

fpps_cdra_scale_minus_3 [i] may specify the scale value subtracted 3 for the i-th feature channel. To get the integer scale value, parsed fpps_cdra_scale_minus_3[i] may be added by 3.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A video decoding device, comprising:
a processor configured to:
obtain a feature tensor associated with a video, the feature tensor being associated with a plurality of channels;
adjust a channel dynamic range of a first channel associated with the feature tensor using a first non-linear model;
adjust a channel dynamic range on a second channel associated with the feature tensor using a second non-linear model;
determine reconstructed features based on the adjusted first channel and the adjusted second channel;
obtain at least one of a channel dynamic range adjustment refresh period indication, a probable channel dynamic range adjustment indication, or a common channel dynamic range adjustment indication; and
decode the video based on the determined reconstructed features.

2. The video decoding device of claim 1, wherein the processor is further configured to:
determine the first non-linear model for adjusting the channel dynamic range of the first channel based on a first adjustment parameter; and
determine the second non-linear model for adjusting the channel dynamic range of the second channel based on a second adjustment parameter.

3. The video decoding device of claim 1, wherein the processor is further configured to:
decode a first adjustment parameter for the first channel from video data;
determine the first non-linear model for adjusting the channel dynamic range of the first channel based on the first adjustment parameter;
decode a second adjustment parameter for the second channel from the video data; and
determine the second non-linear model for adjusting the channel dynamic range of the second channel based on the second adjustment parameter.

4. The video decoding device of claim 1, wherein the processor is further configured to:
determine, based on the channel dynamic range adjustment refresh period indication, to decode adjustment parameters for channel dynamic range adjustment;
decode a first adjustment parameter for the first channel from video data;
determine the first non-linear model for adjusting the channel dynamic range of the first channel based on the first adjustment parameter;
decode a second adjustment parameter for the second channel from the video data; and
determine the second non-linear model for adjusting the channel dynamic range of the second channel based on the second adjustment parameter.

5. The video decoding device of claim 1, wherein the processor is further configured to:
determine, based on the channel dynamic range adjustment refresh period indication, to use adjustment parameters associated with a previous picture;
determine the first non-linear model for adjusting the channel dynamic range of the first channel based on a first adjustment parameter associated with the previous picture; and
determine the second non-linear model for adjusting the channel dynamic range of the second channel based on a second adjustment parameter with the previous picture.

6. The video decoding device of claim 1, wherein the probable channel dynamic range adjustment indication configured to indicate a default channel dynamic range adjustment parameter value, and wherein the processor is further configured to:
obtain, for the first channel associated with the feature tensor, a probable channel dynamic range adjustment usage indication;
determine, based on the probable channel dynamic range adjustment usage indication associated with the first channel, to use the default channel dynamic range adjustment parameter value for the first channel; and
determine the first non-linear model for adjusting the channel dynamic range of the first channel based on the default channel dynamic range adjustment parameter value.

7. The video decoding device of claim 1, wherein the probable channel dynamic range adjustment indication configured to indicate a default channel dynamic range adjustment parameter value, and wherein the processor is further configured to:
obtain, for the first channel associated with the feature tensor, a probable channel dynamic range adjustment usage indication;
determine, based on the probable channel dynamic range adjustment usage indication associated with the first channel, to not use the default channel dynamic range adjustment parameter value for the first channel;
decode an adjustment parameter for the first channel from video data; and
determine the first non-linear model for adjusting the channel dynamic range of the first channel based on the adjustment parameter for the first channel.

8. The video decoding device of claim 1, wherein the common channel dynamic range adjustment indication configured to indicate whether to use a common channel dynamic range adjustment parameter value for channels associated with the feature tensor, and wherein the processor is further configured to:
determine, based on the common channel dynamic range adjustment indication, to use the common channel dynamic range adjustment parameter value for channels associated with the feature tensor;
determine the first non-linear model for adjusting the channel dynamic range of the first channel based on the common channel dynamic range adjustment parameter value; and
determine the second non-linear model for adjusting the channel dynamic range of the second channel based on the common channel dynamic range adjustment parameter.

9. The video decoding device of claim 1, wherein the common channel dynamic range adjustment indication configured to indicate whether to use a common channel dynamic range adjustment parameter value for channels associated with the feature tensor, wherein the common channel dynamic range adjustment indication is obtained based on video data, and wherein the processor is further configured to:
determine, based on the common channel dynamic range adjustment indication, to not use the common channel dynamic range adjustment parameter value for channels associated with the feature tensor;
determine a first adjustment parameter for the first channel based on the video data;
determine a second adjustment parameter for the second channel based on the video data;
determine the first non-linear model for adjusting the channel dynamic range of the first channel based on the first adjustment parameter; and
determine the second non-linear model for adjusting the channel dynamic range of the second channel based on the second adjustment parameter.

10. A video encoding device, the video encoding device comprising:
a processor configured to:
obtain a feature tensor associated with a video;
adjust a channel dynamic range of a first channel associated with the feature tensor using a first non-linear model;
adjust a channel dynamic range on a second channel associated with the feature tensor using a second non-linear model;
determine a plurality of adjustment parameters associated with a plurality of channels; and
encode the video based on the adjusted feature tensor having the first channel and the second channel.

11. The video encoding device of claim 10, wherein the first non-linear model is associated with a first adjustment parameter, and the second non-linear model is associated with a second adjustment parameter.

12. The video encoding device of claim 10, wherein the processor is further configured to:
determine a first adjustment parameter associated with the first non-linear model for adjusting the channel dynamic range of the first channel;
determine a second adjustment parameter associated with the second non-linear model for adjusting the channel dynamic range of the second channel; and
include in video data an indication of the first adjustment parameter and the second adjustment parameter.

13. The video encoding device of claim 10, wherein the feature tensor being associated with the plurality of channels, and the processor is further configured to:
determine a default channel dynamic range adjustment parameter value based on the plurality of adjustment parameters associated with the plurality of channels; and
include in video data a probable channel dynamic range adjustment indication configured to indicate the default channel dynamic range adjustment parameter value.

14. The video encoding device of claim 10, wherein the feature tensor being associated with the plurality of channels, and the processor is further configured to:
determine a default channel dynamic range adjustment parameter value based on the plurality of adjustment parameters associated with the plurality of channels;
determine, for the first channel associated with the feature tensor, a first probable channel dynamic range adjustment usage indication, based on the default channel dynamic range adjustment parameter value and a first adjustment parameter associated with the first non-linear model for adjusting the channel dynamic range of the first channel;
determine, for the second channel associated with the feature tensor, a second probable channel dynamic range adjustment usage indication, based on the default channel dynamic range adjustment parameter value and a second adjustment parameter associated with the second non-linear model for adjusting the channel dynamic range of the second channel; and
include, in video data, a probable channel dynamic range adjustment indication configured to indicate the default channel dynamic range adjustment parameter value, the first probable channel dynamic range adjustment usage indication for the first channel, and the second probable channel dynamic range adjustment usage indication for the second channel.

15. The video encoding device of claim 10, wherein the processor is further configured to:
determine whether to use a common channel dynamic range adjustment parameter value for channels associated with the feature tensor;
based on a determination not use the common channel dynamic range adjustment parameter value for channels associated with the feature tensor, determine a first adjustment parameter for the first channel and a second adjustment parameter for the second channel;
include, in video data, a common channel dynamic range adjustment indication indicating to not use the common channel dynamic range adjustment parameter value for channels associated with the feature tensor; and
include in the video data an indication of the first adjustment parameter and an indication of the second adjustment parameter.

16. The video encoding device of claim 10, wherein the processor is further configured to:
determine a channel dynamic range adjustment refresh period; and
include, in video data, a channel dynamic range adjustment refresh period indication configured to indicate the determined channel dynamic range adjustment refresh period.

17. The video encoding device of claim 10, wherein the first and second non-linear models are associated with a logit function.

18. A video decoding method, comprising:
obtaining a feature tensor associated with a video, the feature tensor being associated with a plurality of channels;
adjusting a channel dynamic range of a first channel associated with the feature tensor using a first non-linear model;
adjusting a channel dynamic range on a second channel associated with the feature tensor using a second non-linear model;
determining reconstructed features based on the adjusted first channel and the adjusted second channel;
obtaining at least one of a channel dynamic range adjustment refresh period indication, a probable channel dynamic range adjustment indication, or a common channel dynamic range adjustment indication; and
decoding the video based on the determined reconstructed features.

19. The method of claim 18, further comprising:
determining the first non-linear model for adjusting the channel dynamic range of the first channel based on a first adjustment parameter; and
determining the second non-linear model for adjusting the channel dynamic range of the second channel based on a second adjustment parameter.

20. The method of claim 18, wherein the first and second non-linear models are associated with a logit function.
